(19) United States
(12) Patent Application Publication
(10) Pub. No.: US 2013/0051196 A1
(43) Pub. Date: Feb. 28, 2013

(54) TIMEPIECE DIAL AND TIMEPIECE

(71) Applicant: Koki TAKASAWA, Suwa-shi (JP)

(72) Inventor: Koki TAKASAWA, Suwa-shi (JP)

(73) Assignee: SEIKO EPSON CORPORATION, Tokyo (JP)

(21) Appl. No.: 13/569,540

(22) Filed: Aug. 8, 2012

(30) Foreign Application Priority Data
Aug. 25, 2011 (JP) 2011-184072
Sep. 12, 2011 (JP) 2011-198771

(51) Int. Cl. G04B 19/08

(52) U.S. Cl. 368/234

(57) ABSTRACT

To provide a timepiece dial that presents an appearance with a rich stereoscopic effect, and to provide a timepiece including the timepiece dial, a timepiece dial of the present invention includes a microlens layer formed with a plurality of microlenses which are arranged in an orderly fashion in a planar view; and a decorative layer formed with a design having a plurality of lines. The microlens layer and the decorative layer are superimposed as viewed in a planar view of the timepiece dial. A pitch of adjacent lines of the design changes along a longitudinal direction of a linear reference line.

### CROSS-REFERENCE TO RELATED APPLICATIONS

This application claims priority to Japanese Patent Application No. 2011-184072 filed on Aug. 25, 2011 and Japanese Patent Application No. 2011-198771 filed on Sep. 12, 2011. The entire disclosure of Japanese Patent Application Nos. 2011-184072 and 2011-198771 is hereby incorporated herein by reference.

### BACKGROUND

1. Technical Field

The present invention relates to a timepiece dial and a timepiece.

2. Background Technology

Timepieces and timepiece dials require functionality as a commercial product and decorative aspects (an aesthetic appearance) as a decorative ornament. Well-known dials for a timepiece are typically composed of a metal material in order to yield an appearance that imparts a sense of luxury. However, with a well-known timepiece dial, the range of the appearance that can be expressed is limited and it is not possible to sufficiently respond to consumer needs. For example, there is considerable need for a timepiece provided with a dial that presents an appearance having a stereoscopic effect, and a timepiece dial has been proposed in which a plurality of designs and other patterns are formed and layered in alternating fashion with transparent films (see Patent Document 1).

However, with such a timepiece dial, a stereoscopic effect having a thickness equal to or greater than that of the timepiece dial cannot be expressed, and it is also difficult to significantly increase the thickness of the timepiece dial itself due to thickness limitations. Therefore, needs such as those described above cannot be sufficiently met. In the particular case of the dial applied to a portable timepiece such as a wristwatch, there is a considerable limitation to the thickness of the timepiece overall, and it is very difficult to achieve an appearance having a rich stereoscopic effect.

Japanese Laid-open Patent Application No. 2-306188 (Patent Document 1) is an example of the related art.

### SUMMARY

### Problems to Be Solved by the Invention

An advantage of the present invention is to provide a timepiece dial that presents a rich stereoscopic effect, and to provide a timepiece provided with such a timepiece dial.

### Means Used to Solve the Above-Mentioned Problems

The advantages described above are achieved by the present invention described below. A timepiece dial of the timepiece dial includes a microlens layer formed with a plurality of microlenses which are arranged in an orderly fashion as viewed in a planar view; and a decorative layer formed with a design having a plurality of lines; wherein the microlens layer and the decorative layer are superimposed as viewed in a planar view. It is thus possible to provide a timepiece dial that presents an appearance having a rich stereoscopic effect.

In the timepiece dial of the present invention, it is preferable that a pitch of adjacent lines of the design changes along a longitudinal direction of a linear reference line. It is thus possible to provide a timepiece dial that presents an appearance having a rich stereoscopic effect and a particularly excellent aesthetic appearance can be imparted to a timepiece dial. In the timepiece dial of the present invention, it is preferable that the plurality of lines of the design are that a change ratio of the pitch per unit length of the reference line is equal to each other in each section of the longitudinal direction of the linear reference line. It is thus possible to provide a timepiece dial that presents an appearance having a rich stereoscopic effect and a particularly excellent aesthetic appearance can be imparted to a timepiece dial. In the timepiece dial of the present invention, it is preferable that the pitch of the adjacent lines of the design is 40 μm or more and 550 μm or less. Thus, a particularly excellent aesthetic appearance can be imparted to a timepiece dial.

In the present invention, it is preferable that a pitch P_{ML} [μm] of the microlenses and a pitch P_{R} [μm] of the adjacent lines of the design satisfy the relationship of 0.5≦P_{R}/P_{ML}≦1.5. It is thus possible to provide a timepiece dial that presents an appearance having a rich stereoscopic effect and a particularly excellent aesthetic appearance can be imparted to a timepiece dial.

In the present invention, it is preferable that a focal distance L₀ [μm] of the microlenses and a distance L₁ [μm] from a lens surface of the microlenses to a surface of the decorative layer satisfy the relationship of 0.5≦L₁/L₀≦1.5. It is thus possible to provide a timepiece dial that presents an appearance having a rich stereoscopic effect and a particularly excellent aesthetic appearance can be imparted to a timepiece dial.

In the present invention, it is preferable that the decorative layer is that in the lines of the design, a pitch of adjacent other lines of the design changes along the longitudinal direction of the lines of the design. Thus, a particularly excellent aesthetic appearance can be imparted to a timepiece dial.

In the present invention, the decorative layer has a first group of lines formed of the plurality of the lines of the design which are not crossed or contacted from each other, and a second group of lines formed of the plurality of the lines of the design which are not crossed or contacted from each other; it is preferable that at least one of the lines of the design constituting the first group of lines and at least one of the lines of the design constituting the second group of lines are crossed. It is thus possible to provide the timepiece dial with a particular excellent stereoscopic effect. Also, it is possible to advantageously express the appearance of the complex concave-convex shape (for example, an appearance such as a topographical map) which was difficult to express by the various molding methods, the mechanical processing and the like.

In the timepiece of the present invention, it is preferable that the decorative layer is that in the lines of the design, the change ratio of the pitch per unit length of the lines of the design is not constant. It is thus possible to provide the timepiece dial with a particular excellent stereoscopic effect. Also, it is possible to advantageously express the appearance of the complex concave-convex shape (for example, an appearance such as a topographical map) which was difficult to express by the various molding methods, the mechanical processing and the like.

In the timepiece of the present invention, it is preferable that in a case where the centers of microlenses that are adjacent as viewed in a planar view are connected by a straight line, a plurality of triangles are arranged in an orderly fashion by the straight line. It is thus possible to provide the timepiece dial with a particular excellent stereoscopic effect and a particularly excellent aesthetic appearance. In the timepiece of the present invention, it is preferable that the triangles are equilateral triangles. It is thus possible to provide the timepiece dial with a particular excellent stereoscopic effect and a particularly excellent aesthetic appearance.

In the timepiece of the present invention, it is preferable that in a case where the centers of adjacent microlenses as viewed in a planar view of the timepiece dial are connected by a straight line, a plurality of quadrangles are arranged in an orderly fashion by the straight line. It is thus possible to provide the timepiece dial with a particular excellent stereoscopic effect and a particularly excellent aesthetic appearance. In the timepiece of the present invention, it is preferable that the quadrangles are squares. It is thus possible to provide the timepiece dial with a particular excellent stereoscopic effect and a particularly excellent aesthetic appearance.

In the timepiece of the present invention, it is preferable that the distance from the lens surface of the microlenses to the surface of the decorative layer is 100 μm or more and 1000 μm or less. It is thus possible to provide a timepiece dial that presents an appearance having a rich stereoscopic effect and a particularly excellent aesthetic appearance can be imparted to a timepiece dial. In the timepiece of the present invention, it is preferable that the focal distance of the microlenses is 100 μm or more and 1000 μm or less. Thus, a particularly excellent aesthetic appearance can be imparted to a timepiece dial. In the timepiece of the present invention, it is preferable that the pitch of the microlenses is 50 μm or more and 500 μm or less. Thus, a particularly excellent aesthetic appearance can be imparted to a timepiece dial.

In the timepiece of the present invention, it is preferable that the lines of the design of the decorative layer and the microlenses of the microlens layer are provided in at least a portion where time characters are not provided as viewed in a planar view of the timepiece dial, and in a portion where the time characters are provided, the lines of the design of the decorative layer and/or the microlenses of the microlens layer are not provided. It is thus possible to impart a particularly excellent time visibility as well as an excellent aesthetic appearance of the timepiece dial, and it is possible to achieve a higher level of both practicality as a commercial product and an aesthetic appearance as a decoration. The timepiece of the present invention includes the timepiece dial of the present invention. It is thus possible to provide a timepiece including a timepiece dial that presents an appearance having a rich stereoscopic effect.

### Effect of the Invention

According to the present invention, it is possible to provide a timepiece dial that presents an appearance having a rich stereoscopic effect, and to provide a timepiece having such a timepiece dial.

### BRIEF DESCRIPTION OF THE DRAWINGS

Referring now to the attached drawings which form a part of this original disclosure:

FIG. 1 is a plan view showing the first embodiment of the timepiece dial of the present invention;

FIG. 2 is a cross-sectional view of the timepiece dial as shown in FIG. 1;

FIG. 3 is a plan view showing the second embodiment of the timepiece dial of the present invention;

FIG. 4 is a plan view showing the third embodiment of the timepiece dial of the present invention;

FIG. 5 is a plan view showing the fourth embodiment of the timepiece dial of the present invention;

FIG. 6 is a cross-sectional view of the timepiece dial as shown in FIG. 5;

FIG. 7 is a plan view showing the fifth embodiment of the timepiece dial of the present invention; and

FIG. 8 is a part of the cross-sectional view showing the preferred embodiment of the timepiece (portable timepiece) of the present invention.

### DETAILED DESCRIPTION OF EXEMPLARY EMBODIMENTS

Preferred embodiments of the present invention will be described below with reference to the accompanying drawings. A preferred embodiment of the timepiece dial of the present invention will be described first.

### Timepiece Dial

### First Embodiment

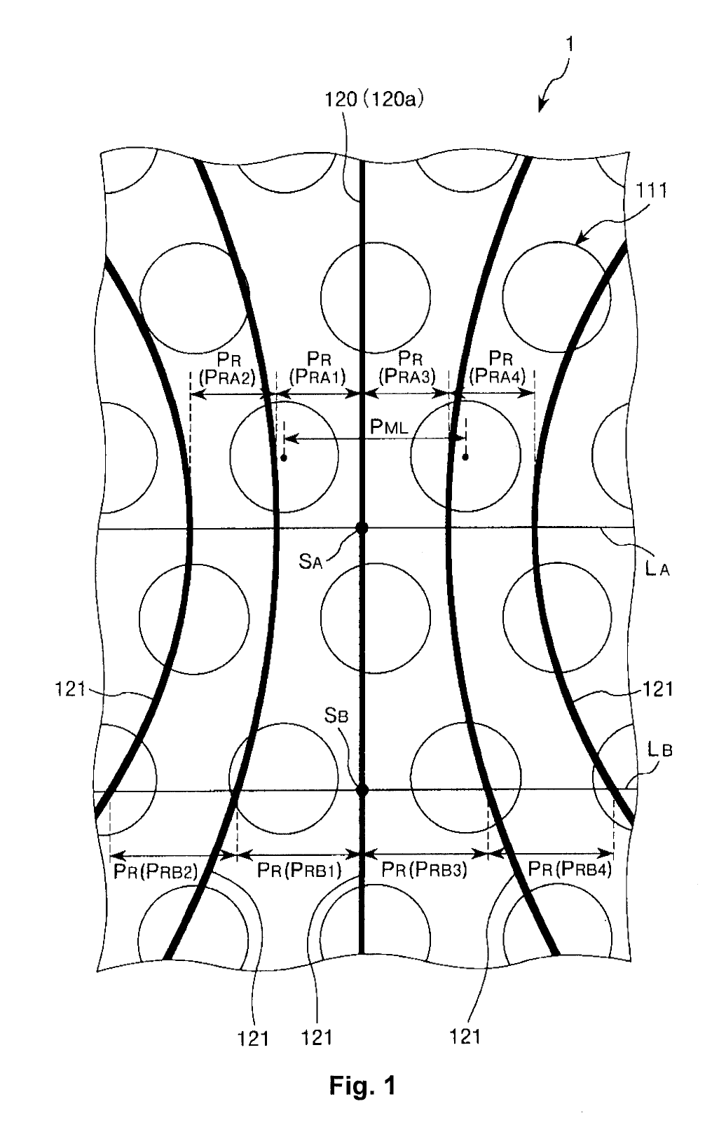

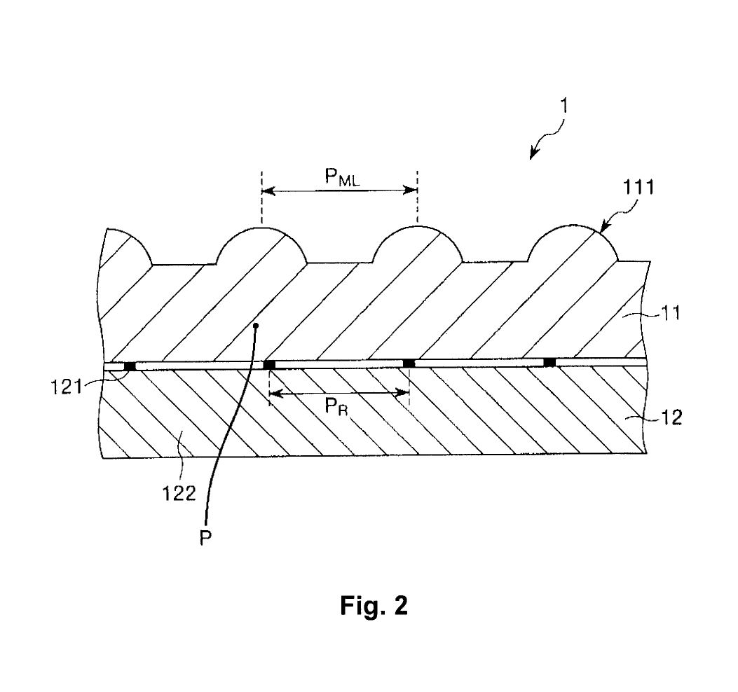

FIG. 1 is a plan view showing the first embodiment of the timepiece dial of the present invention. FIG. 2 is a cross-sectional view of the timepiece dial as shown in FIG. 1. The drawings referred to in the present specification show part of the configuration in an exaggerated fashion, and they do not reflect actual dimensions etc. correctly.

As shown in the drawings, the timepiece dial 1 includes a microlens layer 11 and a decorative layer 12. The microlens layer 11 is formed with a plurality of microlenses 111 which are arranged in an orderly fashion when the timepiece dial 1 (microlens layer 11) is viewed from above. The decorative layer 12 is formed with a design having a plurality of lines (linear design) 121. The microlens layer 11 and the decorative layer 12 are superimposed when the timepiece dial 1 is viewed from above.

As a result of thoroughgoing research, the present inventors found that by configuring the timepiece dial in this manner, it is possible to provide a timepiece dial that makes use of visual optical interference (moiré) and presents an appearance having a rich stereoscopic effect. In particular, as a result of thoroughgoing research, the present inventors found that it is possible to provide a timepiece dial that can be discerned by an observer, through sensory misperception, to have a thickness that is equal to or greater than the real thickness of the timepiece dial. The timepiece dial 1 is used such that the microlens layer 11 is arranged closer to the observer side (external surface side) than the decorative layer 12.

### Microlens Layer

The microlens layer 11 is formed with a plurality of microlenses 111 which are arranged in an orderly fashion. Specifically, in the present embodiment, the plurality of microlenses 111 are arranged such that in a case where the centers of microlenses 111 that are adjacent when the timepiece dial 1 is viewed from above are connected by a straight line, a plurality of triangles are arranged in an orderly fashion by the straight line. Thus, a particularly excellent aesthetic appearance can be imparted to the timepiece dial 1. Also, the triangles are equilateral triangles. Thus, a more particularly excellent aesthetic appearance can be imparted to the timepiece dial 1.

The focal distance of the microlenses 111 is preferably 100 μm or more and 1000 μm or less, and more preferably 150 μm or more and 500 μm or less. Thus, a particularly excellent aesthetic appearance can be imparted to the timepiece dial 1. The focal point is shown as P in the drawing. The pitch N_{ML} of the microlenses 111 (when the timepiece dial 1 is viewed from above) is preferably 50 μm or more and 500 μm or less, and more preferably 60 μm or more and 300 μm or less. Thus, a particularly excellent aesthetic appearance can be imparted to the timepiece dial 1. In the present invention, the pitch of the microlenses refers to a distance between the centers of microlenses that are adjacent when the timepiece dial 1 is viewed from above.

The microlens layer 11 is composed of a material having optical transmission properties. In the present invention, the phrase “having optical transmission properties” refers to having a property in which at least a portion of light in the visible light region (wavelength region of 380 to 780 nm) is transmitted; the transmissivity of light in the visible light region is preferably 50% or more; and more preferably, the transmissivity of light in the visible light region is 60% or more. Such light transmissivity can be obtained as follows, for example. By using white fluorescent light (FL20S-D65: a fluorescent light for examination manufactured by Toshiba Corp.) as the light source, an electric current value (x) when power is generated at 1000 lux only by a solar cell (solar battery) having the same shape as the member to be measured (or the timepiece dial) is obtained. Also, an electric current value (Y) when power is generated in the same state except that the member to be measured (or the timepiece dial) is placed on the light source side of the solar cell is obtained. Then, the ratio of Y to X ((Y/X)×100[%]) obtained as above can be used as light transmissivity. Hereinafter, in this application, the phrase “transmissivity of light” indicates the value obtained in this condition except that there is any prior indication.

Examples of the material constituting the microlens layer 11 include various plastics materials and various glass materials, but the microlens layer 11 is preferably composed mainly of a plastic material. Plastic materials generally have excellent moldability (degree of freedom of molding), and can be advantageously used for manufacturing the timepiece dial 1 in various shapes. Also, a microlens layer 11 composed of plastic material is advantageous for reducing the manufacturing cost of the timepiece dial 1. Further, plastic materials generally have excellent light (visible light) transmissivity, and also have excellent radio wave transmissivity. Therefore, when the microlens layer 11 is composed of a plastic material, the timepiece dial 1 can be advantageously applied to a solar timepiece (a timepiece provided with a solar battery) and a radio timepiece. The focus of the description below is an example in which the microlens layer 11 is mainly composed of a plastic material. In the present invention, the term “mainly” refers to a component present in the greatest amount content among the materials constituting the parts (members) under discussion. The content is not particularly limited, but is preferably 60 wt % or more, more preferably 80 wt % or more, and even more preferably 90 wt % or more of the material constituting the part (member) under discussion.

The plastic material constituting the microlens layer 11 can be any of a variety of thermoplastic resins, thermosetting resins, or the like. For example, this includes polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; epoxy resins; urethane resins; and copolymers, blends, polymer alloys, or the like composed mainly of these. Also, one or more of these can be used in combination (e.g., blend resins, polymer alloys, laminates, and the like). Specifically, it is particularly preferred that the microlens layer 11 be mainly composed of polycarbonate. The microlenses 111 can thereby be endowed with greater transparency, the refractive index of the microlenses 111 can be made optimal, and a particularly excellent aesthetic appearance can thereby be imparted to the timepiece dial 1 overall. Also, a timepiece dial 1 having particularly excellent reliability can be obtained because the strength of the timepiece dial 1 overall can thereby be made particularly excellent, the microlenses 111 having greater dimensional precession can be obtained, and unwanted deformations of the microlenses 111 or other anomalies can be more reliably prevented. In the case that the microlens layer 11 is composed of an acrylic resin, a polyester resin, an epoxy resin, or a urethane resin, the microlenses 111 can be more advantageously formed by a printing method (in particular, a droplet discharge method such as an inkjet method).

The microlens layer 11 can include components other than plastic material. Examples of such components include plasticizers, antioxidants, colorants (including various color formers, fluorescent substances, phosphorescent substances, and the like), brighteners, and fillers. For example, when the microlens layer 11 is composed of a material that includes a colorant, color variations of the timepiece dial 1 can be increased.

The microlens layer 11 can have an essentially uniform composition in each part, or can have a different composition depending on the part. The refractive index (absolute refractive index) of the microlens layer 11 is preferably 1.500 or more and 1.650 or less, and more preferably 1.550 or more and 1.600 or less. Thus, a particularly excellent aesthetic appearance can be imparted to the timepiece dial 1. In the configuration shown in the drawings, the microlenses 111 are substantially spherical in shape, and are spherical lenses that form a circular shape when viewed from above, but the shape of the microlenses 111 is not particularly limited. For example, it is possible to use a shape that is barrel-shaped (substantially oval shape, elliptical shape), substantially triangular, substantially quadrangular, substantially hexagonal, or the like when viewed from above.

Also, the shape and size of the microlens substrate (microlens layer) 11 is not particularly limited and is ordinarily determined based on the shape and size of the timepiece dial 1 to be manufactured. In the configuration shown in the drawings, the microlens substrate 11 is a flat plate shape, but can also be, e.g., a curved plate shape, or the like. Also, the microlens substrate 11 can be molded using any method; examples of methods for molding the microlens substrate 11 include compression molding, extrusion molding, injection molding, photo fabrication, and the 2P method or the like. Also, the microlens substrate 11 can be, e.g., a plate-shaped member that does not have microlenses 111, whereon a liquid material containing the constituent material of the microlenses 111 is discharged by the inkjet method or another liquid discharge method to thereby form the microlenses 111. Further, the microlenses 111 can be formed using offset printing, gravure printing, or various other types of printing methods. Microlenses formed using a printing method are advantageous in that the production costs of the microlens substrate 11 can be reduced. In the present invention, the shape of at least a portion of the microlenses of the microlens substrate is not required to be circular when viewed from above and can be, e.g., oval-shaped. Also, the plurality of microlenses can be independently arranged or adjacently connected.

### Decorative Layer

A decorative layer 12 has a design 121 formed of a plurality of lines. Specifically, in the timepiece dial 1 of the present invention, the decorative layer (decorative substrate) 12 is provided with the design 121 formed of the lines on a substrate 122. Thus, the design 121 formed of the lines can be more securely fixed, and as a result, an excellent aesthetic appearance of the timepiece dial 1 can be sufficiently demonstrated for long time. In other words, the timepiece dial 1 having particularly excellent reliability can be obtained.

The decorative layer 12 has the design 121 formed of the plurality of lines, but in the present embodiment, a pitch of the adjacent lines of the design 121 changes along a longitudinal direction of a linear reference line 120 (120a) which is in a linear fashion. It is thus possible to provide the appearance of the timepiece dial 1 with a richer stereoscopic effect and to impart a particularly excellent aesthetic appearance to the timepiece dial 1. In the configuration of the drawings, the linear reference line 120 is one of the plurality of lines of the design 121 constituting the decorative layer 12. However, the linear reference line 120 is a conceptual, and does not need to be the lines of the design 121 constituting the decorative layer 12.

The amount of the above change of the pitch per unit length (1 cm) of the reference line 120 is preferably 0.4 μm or more and 16 μm or less, and more preferably 0.5 μm or more and 10 μm or less. In other words, the ratio of the above change of the pitch per unit length (1 cm) of the reference line 120 is preferably 0.20% or more and 4.5% or less, and more preferably 0.25% or more and 2.8% or less. It is thus possible to provide the appearance of the timepiece dial 1 with a richer stereoscopic effect and to impart a particularly excellent aesthetic appearance to the timepiece dial 1.

Regarding the plurality of lines of the design 121, the ratio of the above change of the pitch per unit length of the reference line 120 is preferably the same in each section of the longitudinal direction of the linear reference line 120. For example, the pitches P_{RA1} [μm], P_{RA2} [μm], P_{RA3} [μm], and P_{RA4} [μm] of the lines of the design 121 adjacent in a line L_{A} perpendicular to the reference line 120 passing through a point S_{A} on the reference line 120; and the pitches P_{RB1} [μm], P_{RB2} [μm], P_{RB3} [μm], and P_{RB4} [μm] of the lines of the design 121 adjacent in a line L_{B} perpendicular to the reference line 120 passing through a point S_{B} on the reference line 120 satisfy the relationship of P_{RA1}/P_{RB1}=P_{RA2}/P_{RB2}=P_{RA3}/P_{RB3}=P_{RA4}/P_{RB4}. It is thus possible to provide the appearance of the timepiece dial 1 with a richer stereoscopic effect and to impart a particularly excellent aesthetic appearance to the timepiece dial 1. The pitches (for example, P_{RA1}, P_{RA1}, P_{RA2}, P_{RA3}, and P_{RA4}) of the lines of the design 121 adjacent in a line perpendicular to the reference line 120 passing through an arbitrary point on the reference line 120 can be different, but preferably are the same. It is thus possible to impart a particularly excellent aesthetic appearance to the timepiece dial 1.

The pitch P_{R} of the adjacent lines of the design 121 (the pitch in a direction perpendicular to the reference line 120 when the timepiece dial 1 is viewed from above) is preferably 40 μm or more and 550 μm or less, and more preferably 50 μm or more and 350 μm or less. Thus, a particularly excellent aesthetic appearance can be imparted to the timepiece dial 1. In the configuration shown in the drawing, the pitch of the adjacent lines of the design 121 changes along a longitudinal direction of the linear reference line 120. In such a case, preferably, the above-described conditions are satisfied in at least part of the region of the timepiece dial 1, and more preferably, the above-described conditions are satisfied in the entire region of the timepiece dial 1.

The pitch P_{ML} [μm] of the microlenses 111 and the pitch P_{R} [μm] of the adjacent lines of the design 121 preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece dial 1 with a richer stereoscopic effect and to impart a particularly excellent aesthetic appearance to the timepiece dial 1. In the present embodiment, the pitch of the adjacent lines of the design 121 changes along a longitudinal direction of the linear reference line 120. In such a case, preferably, the above-described conditions are satisfied in at least part of the region of the timepiece dial 1, and more preferably, the above-described conditions are satisfied in the entire region of the timepiece dial 1. When the pitch of the adjacent lines of the design 121 is less than the pitch of the microlenses 111, the design will appear to be recessed. On the other hand, when the pitch of the adjacent lines of the design 121 is greater than the pitch of the microlenses 111, the design will appear to be floating.

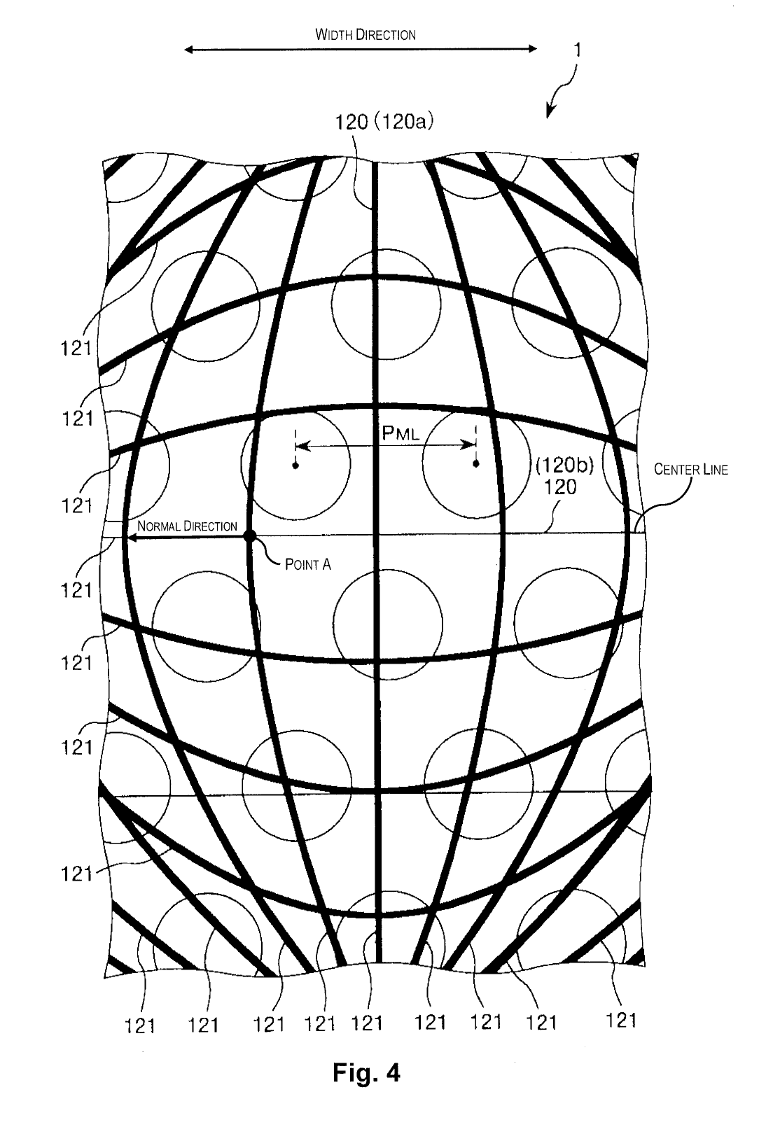

The linear design 121 can be composed of any material, examples of which include various pigments, various dyes, and other colorants; and materials containing a metal material. The linear design 121 can be composed of a material containing a resin material. It is thus possible to cause the linear design 121 to have particularly exceptional adhesion to the substrate 122. In the configuration that the linear design 121 is directly formed on the surface of the microlens layer (microlens substrate) 11 as shown in FIG. 4 which will discuss later, the linear design 121 is composed of a material containing a resin material so as to cause the linear design 121 to have particularly exceptional adhesion to the microlens substrate 11. The linear design 121 can be formed using any method, examples of which include screen printing, gravure printing, pad printing, an inkjet method, and various other printing methods. Also, etching treatment is carried out on a film formed on the substrate 122, and the remaining portion can be used as the linear design 121.

The substrate 122 can be composed of any material as long as the substrate 122 has a functionality of maintaining the linear design 121. However, it is preferable that the substrate 122 is composed of the plastic material because of the durability, the easiness of use or the like of the timepiece dial 1. Also, when the substrate 122 is composed of a material having optical transmission properties, the timepiece dial 1 can be advantageously applied to a solar timepiece (a timepiece provided with a solar battery).

The plastic material constituting the substrate 122 can be any of a variety of thermoplastic resins, thermosetting resins, or the like. For example, this includes polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; epoxy resins; urethane resins; and copolymers, blends, polymer alloys, or the like composed mainly of these. Also, one or more of these can be used in combination (e.g., blend resins, polymer alloys, laminates, and the like). Specifically, it is particularly preferred that the substrate 122 be mainly composed of polycarbonate. Thus, a timepiece dial 1 having particularly excellent reliability can be obtained because the strength of the timepiece dial 1 overall can be made particularly excellent and unwanted deformations of the linear design 121 or other anomalies can be more reliably prevented.

The substrate 122 can include components other than plastic material. Examples of such components include plasticizers, antioxidants, colorants (including various color formers, fluorescent substances, phosphorescent substances, and the like), brighteners, and fillers. For example, when the substrate 122 is composed of a material that includes a colorant, color variations of the timepiece dial 1 can be increased. The substrate 122 can have an essentially uniform composition in each part, or can have a different composition depending on the part.

The distance from the lens surface of the microlenses 111 (the upper-side surface in FIG. 2) to the surface of the decorative layer 12 (the upper-side surface in FIG. 2) is preferably 100 μm or more and 1000 μm or less, and more preferably 150 μm or more and 500 μm or less. It is thus possible to provide the appearance of the timepiece dial 1 with a richer stereoscopic effect and to impart a particularly excellent aesthetic appearance to the timepiece dial 1.

Specifically, in the present embodiment, in a case where the plurality of microlenses 111 are arranged such that if the centers of microlenses 111 that are adjacent when the timepiece dial 1 is viewed from above are connected by a straight line, a plurality of equilateral triangles are arranged in an orderly fashion by the straight line, the distance from the lens surface of the microlenses 111 (the upper-side surface in FIG. 2) to the surface of the decorative layer 12 (the upper-side surface in FIG. 2) is preferably 150 μm or more and 500 μm or less, and more preferably 150 μm or more and 300 μm or less. It is thus possible to provide the appearance of the timepiece dial 1 with a richer stereoscopic effect and to impart a particularly excellent aesthetic appearance to the timepiece dial 1.

The focal distance L₀ [μm] of the microlenses 111 and the distance L₁ [μm] from the lens surface of the microlenses 111 to the surface of the decorative layer 12 preferably satisfy the relationship of 0.5≦L₁/L₀≦1.5, and more preferably satisfy the relationship of 0.6≦L₁/L₀≦1.4. It is thus possible to provide the appearance of the timepiece dial 1 with a richer stereoscopic effect and to impart a particularly excellent aesthetic appearance to the timepiece dial 1. The shape and size of the decorative substrate (decorative layer) 12 is not particularly limited, and is ordinarily determined based on the shape and size of the timepiece dial 1 to be manufactured. In the configuration shown in the drawings, the decorative layer 12 is a flat plate shape, but can also be, e.g., a curved plate shape, or the like.

In the timepiece dial 1, the linear design 121 and microlenses 111 are provided in at least a portion where the time characters are not provided when the timepiece dial 1 is viewed from above. In a portion where the time characters are provided, it is preferable not to provide the linear design 121 and/or the microlenses 111. It is thus possible to impart a particularly excellent time visibility as well as an excellent aesthetic appearance of the timepiece dial 1, and it is possible to achieve a higher level of both practicality as a commercial product and an aesthetic appearance as a decoration.

In the configuration shown in the drawing, the microlens layer (microlens substrate) 11 and the decorative layer (decorative substrate) 12 are in close contact, and thereby the distance between the microlenses 111 and the lines of the design 121 can be kept constant. Thus, a stably excellent aesthetic appearance can be imparted to the timepiece dial 1. Also, the timepiece dial 1 is preferably applied to a portable timepiece (e.g., a wristwatch). Portable timepieces are timepieces having a particular requirement for thinness, and in accordance with the present invention, the stereoscopic effect of the timepiece dial can be made sufficiently excellent while the timepiece dial is made sufficiently thin. In other words, the effects of the present invention can be more dramatically demonstrated in a case where the timepiece dial of the present invention is applied to a portable timepiece.

### Second Embodiment

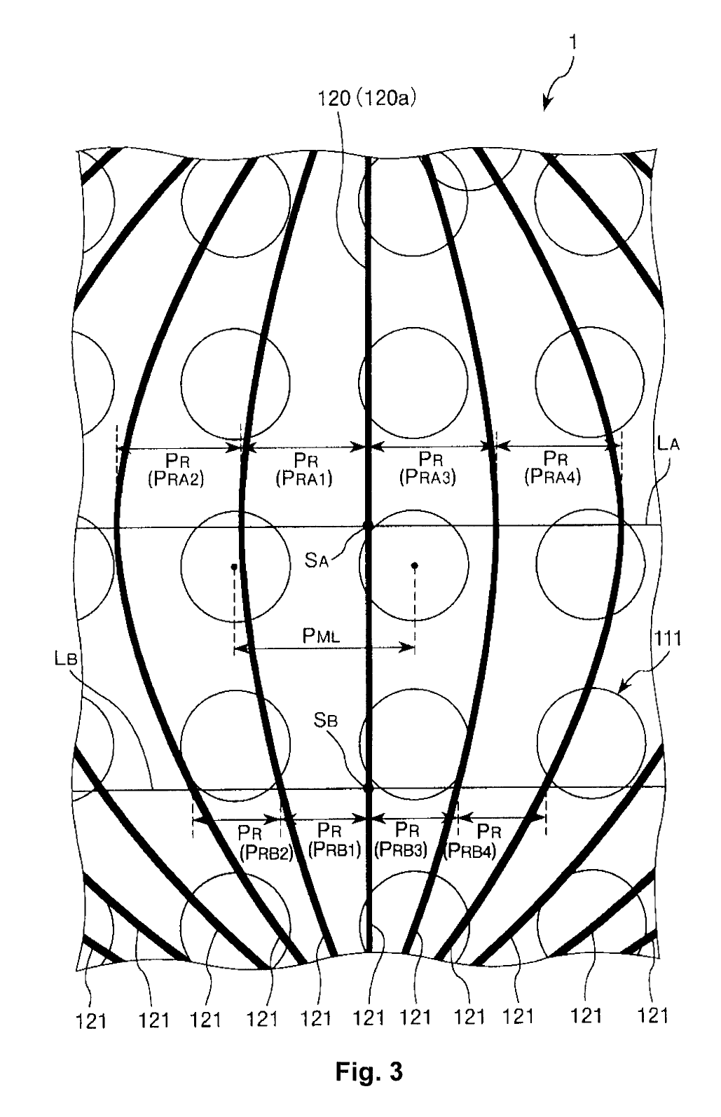

FIG. 3 is a plan view showing the second embodiment of the timepiece dial of the present invention. Hereafter, regarding the timepiece dial of the second embodiment, the points which are different from the previously described embodiments are focused in the explanation, and the points which are the same as the previously described embodiments are omitted in the explanation. In the timepiece dial 1 of the present embodiment, in a case where the centers of adjacent microlenses 111 when the timepiece dial is viewed from above are connected by a straight line, a plurality of quadrangles are arranged in an orderly fashion by the straight line. As described above, in the present embodiment, the arrangement pattern of the microlenses is not limited as explained in the first embodiment. The arrangement pattern can be as described in the present embodiment so that the above-described same effects can be exerted. Also, in the arrangement pattern as described in the present embodiment, it is possible to provide the appearance of the timepiece dial 1 with a stereoscopic effect and to impart an excellent aesthetic appearance to the timepiece dial 1.

Also, in the configuration of the drawings, the quadrangles are squares. Thus, it is possible to provide the appearance of the timepiece dial 1 with a stereoscopic effect and to impart a more excellent aesthetic appearance to the timepiece dial 1. Specifically, in the configuration of the present embodiment, the plurality of microlenses 111 are arranged such that, in a case where the centers of microlenses 111 that are adjacent when the timepiece dial 1 is viewed from above are connected by a straight line, a plurality of quadrangles are arranged in an orderly fashion by the straight line. In this arrangement of the plurality of the microlenses 111, the distance from the lens surface of the microlenses 111 (the upper-side surface in FIG. 2) to the surface of the decorative layer 12 (the upper-side surface in FIG. 2) is preferably 100 μm or more and 1000 μm or less, and more preferably 250 μm or more and 600 μm or less. It is thus possible to provide the appearance of the timepiece dial 1 with a richer stereoscopic effect and to impart a particularly excellent aesthetic appearance to the timepiece dial 1.

Also, in the timepiece dial of the present embodiment, the arrangement pattern of the linear design 121 is different from the configuration of the first embodiment. In particular, in the configuration of the first embodiment, the pitch of the adjacent lines of the design 121 is gradually increased from the center of the timepiece dial 1 (the center when viewed from above) to the circumference part (3 o'clock direction and 9 o'clock direction). On the other hand, in the present invention, the pitch of the adjacent lines of the design 121 is gradually reduced from the center of the timepiece dial 1 (the center when viewed from above) to the circumference part (3 o'clock direction and 9 o'clock direction). Therefore, in the present embodiment, the arrangement pattern of the adjacent lines of the design is not limited as explained in the first embodiment. The arrangement pattern can be as described in the present embodiment so that the above-described same effects can be exerted.

### Third Embodiment

FIG. 4 is a plan view showing the third embodiment of the timepiece dial of the present invention. Hereafter, regarding the timepiece dial of the third embodiment, the points which are different from the previously described embodiments are focused in the explanation, and the points which are the same as the previously described embodiments are omitted in the explanation. In the previously described embodiment, the decorative layer 12 has a group of lines (design 121 having a plurality of lines) based on a single linear reference line 120a. However, in the present embodiment, the decorative layer 12 has two groups of lines (a group of lines based on the reference line 120a and a group of lines based on a reference line 120b). Thus, in the present invention, it is possible to have a plurality of groups of lines in the decorative layer.

### Fourth Embodiment

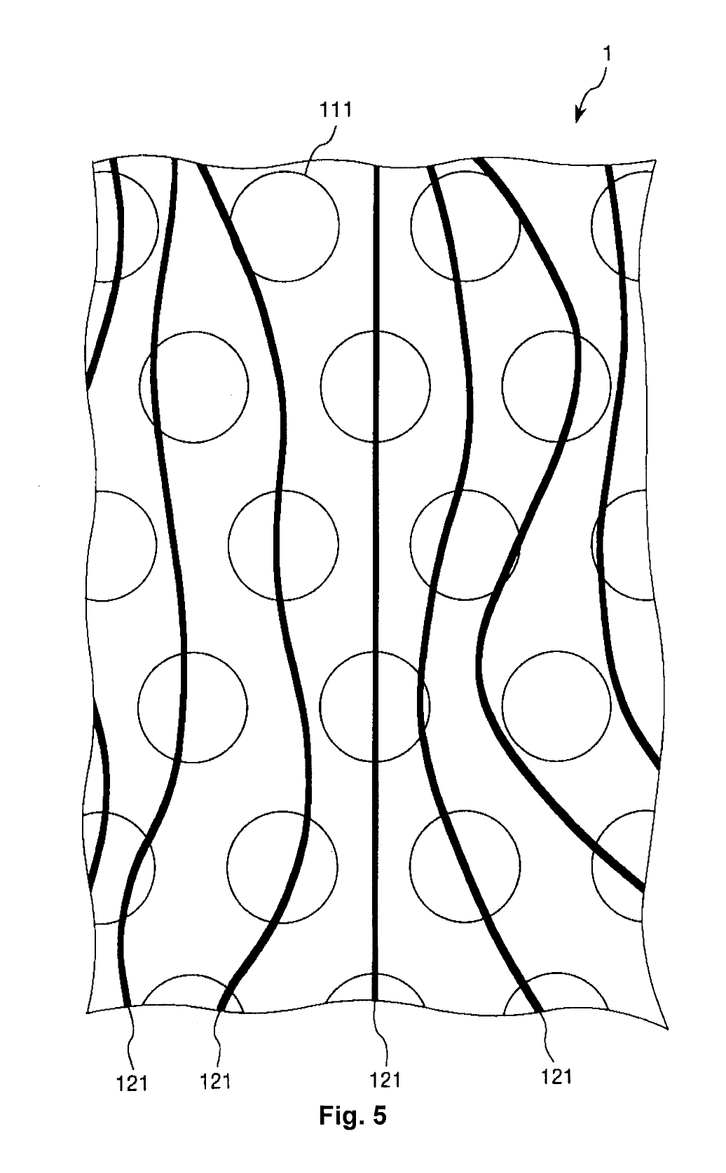

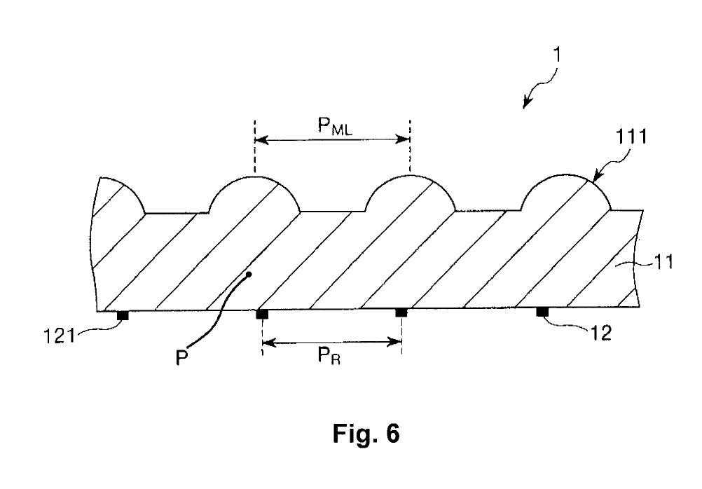

FIG. 5 is a plan view showing the fourth embodiment of the timepiece dial of the present invention. FIG. 6 is a cross-sectional view of the timepiece dial as shown in FIG. 5. Hereafter, regarding the timepiece dial of the fourth embodiment, the points which are different from the previously described embodiments are focused in the explanation, and the points which are the same as the previously described embodiments are omitted in the explanation.

As shown in the drawings, in the present embodiment, the decorative layer 12 has the design 121 formed of the plurality of lines, and a pitch of the adjacent other lines of the design 121 changes along the longitudinal direction.

By configuring the timepiece dial as described, it is possible to provide a timepiece dial that can be discerned by an observer to have a thickness that is equal to or greater than the real thickness of the timepiece dial. In addition, it is also possible to provide a timepiece dial that can be discerned by an observer to have a stereoscopic effect of a concave-convex design in itself as a thickness that is equal to or greater than the real thickness of the timepiece dial.

Also, the timepiece dial having concave and convex is provided by using the molding methods such as a compression molding, an injection molding or the like. In a case that the provided timepiece dial has a complex concave-convex shape, the problems were occurred as follows. In particular, the productivity of the timepiece dial is significantly reduced because it is difficult to separate the molded timepiece dial from a forming die. Also, the defect is easily occurred at the time of the separation and the yield ratio is significantly reduced. In a case that the timepiece dial having concave and convex is produced by cutting and the like of the machine processing, there was a problem that the productivity of the timepiece dial is more reduced. On the other hand, by the present invention, it is possible to provide timepiece dial that can be discerned by an observer to have a complex concave-convex shape.

In the present invention, the pitch of the lines of the design refers to, as a point on the lines of the design (a point through on the center line of the width direction), a distance between the lines of the design that are adjacent in the normal direction on the center line of the width direction. An example of the normal direction from a point A is shown in FIG. 4.

As described above, in the present embodiment, the decorative layer 12 has the design 121 formed of the plurality of lines, and the pitch of the adjacent lines of the design 121 changes along the longitudinal direction. Thus, in a same manner as described in the above embodiments, it is possible to provide a timepiece dial that can be discerned by an observer to have a thickness that is equal to or greater than the real thickness of the timepiece dial. In addition, it is also possible to provide a timepiece dial that can be discerned by an observer to have a stereoscopic effect of a concave-convex design in itself as a thickness that is equal to or greater than the real thickness of the timepiece dial. Specifically, in the present embodiment, a plurality of the lines of the design 121 and particularly, all of the lines of the design 121 satisfy the conditions. It is thus possible to provide the timepiece dial 1 with a particular excellent stereoscopic effect. For example, it is possible to advantageously express a complex stereoscopic shape having a lot of concave and convex such as a wave pattern shape.

In the decorative layer 12, as the lines of the design 121, the ratio of the change of the pitch per unit length is preferably non-constant. It is thus possible to provide the timepiece dial 1 with a particular excellent stereoscopic effect. Also, it is possible to advantageously express the appearance of the complex concave-convex shape (for example, an appearance such as a topographical map expressed with the three dimensional geography having a difference of elevation) which was difficult to express by the various molding methods, the mechanical processing or the like.

Also, the amount of the changes of the pitch per unit length (1 cm) of the lines of the design 121 is preferably 0.4 μm or more and 16 μm or less, and more preferably 0.5 μM or more and 10 μm or less. In particular, the ratio of the change of the above pitch per unit length (1 cm) of the lines of the design 121 is preferably 0.20% or more and 4.5% or less, and more preferably, 0.25% or more and 2.8% or less. It is thus possible to provide the appearance of the timepiece dial 1 with a richer stereoscopic effect and to impart an excellent aesthetic appearance to the timepiece dial 1.

The pitch P_{R} of the adjacent lines of the design 121 is preferably 40 μm or more and 550 μm or less, and more preferably 50 μm or more and 350 μm or less. Thus, a particularly excellent aesthetic appearance can be imparted to the timepiece dial 1. The pitch P_{ML} [μm] of the microlenses 111 and the pitch P_{R} [μm] of the adjacent lines of the design 121 preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece dial 1 with a richer stereoscopic effect and to impart a particularly excellent aesthetic appearance to the timepiece dial 1.

The linear design 121 can be formed using any method, examples of which include screen printing, gravure printing, pad printing, an inkjet method, and various other printing methods. Thus, the microlens layer (microlens substrate) 11 and the lines of the design 121 can be more securely in contact so that the distance between the microlenses 111 and the decorative layer 12 (design) can be more securely kept constant. Consequently, a stably excellent aesthetic appearance can be imparted to the timepiece dial 1.

Among various printing methods, an inkjet method is particularly preferable. By employing an inkjet method, the above-described effects can be exerted significantly, and a fine design can be formed appropriately. Etching treatment is carried out on a film formed on the substrate, and the remaining portion can be used as a repeating design.

Also, in the present embodiment, the decorative layer 12 is not formed on the substrate 122, and the linear design 121 is directly formed on the surface of the microlens layer (microlens substrate) 11. Thus, in the present embodiment, it is possible that the decorative layer does not have the substrate for the linear design. Consequently, the timepiece dial can be made thinner.

### Fifth Embodiment

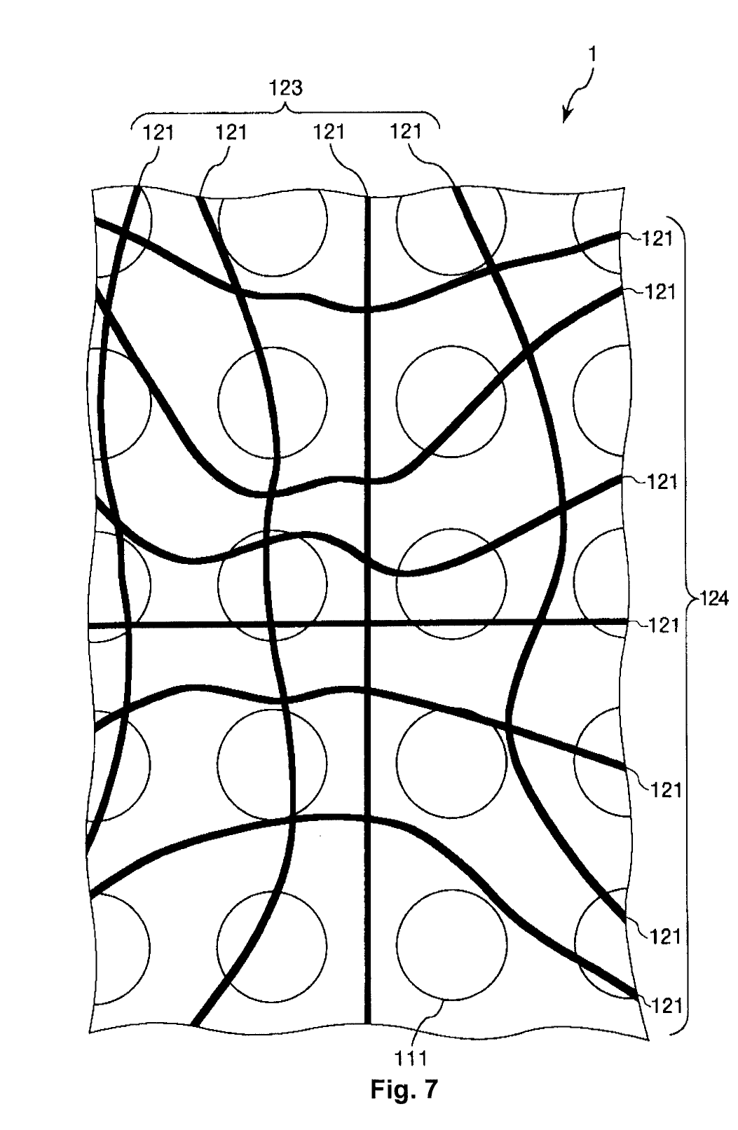

FIG. 7 is a plan view showing the fifth embodiment of the timepiece dial of the present invention. Hereafter, regarding the timepiece dial of the fifth embodiment, the points which are different from the previously described embodiments are focused in the explanation, and the points which are the same as the previously described embodiments are omitted in the explanation. In the fourth embodiment as described above, the decorative layer 12 does not have a plurality of lines of the design 121 which are not crossed or contacted from each other (see FIG. 5). In the present embodiment, the decorative layer 12 has the first group of lines 123 formed of a plurality of the lines of the design 121 which are not crossed or contacted from each other, and the second group of lines 124 formed of a plurality of the lines of the design 121 which are not crossed or contacted from each other. The lines of the design constituting the first group of lines are crossed with the lines of the design constituting the second group. It is thus possible to provide the timepiece dial 1 with a particularly excellent stereoscopic effect. Also, it is possible to advantageously express the appearance of the complex concave-convex shape (for example, an appearance such as a topographical map expressed with the three dimensional geography having a difference of elevation) which was difficult to express by the various molding methods, the mechanical processing or the like. When the above condition is satisfied, one of the lines of the design formed of the first group of lines can be crossed with one of the lines of the design formed of the second group of lines. However, in the configuration of the drawings, the lines of the design formed of the first group of lines are crossed with the lines of the design formed of the second group of lines. Thus, the above-described effects can be exerted significantly.

### Timepiece

Next, the timepiece of the present invention provided with the timepiece dial of the present invention described above is explained. The timepiece of the present invention has the timepiece dial of the present invention described above. As described above, the timepiece dial of the present invention presents an appearance with rich stereoscopic effect. Specifically, the timepiece dial of the present invention is capable of being discerned by an observer, through sensory misperception, to have a thickness that is equal to or greater than the real thickness of the timepiece dial. The timepiece dial of the present invention has excellent decorative characteristics (an excellent aesthetic appearance). Also, excellent optical transmission properties can be imparted to the overall timepiece dial 1 while an excellent appearance such as that described above can be ensured by the selection of the materials of the decorative layer 12, the substrate 122, and the like. Accordingly, the timepiece of the present invention provided with such a timepiece dial can sufficiently satisfy the requirements of a solar timepiece. It is possible to use known components other than the timepiece dial constituting the timepiece of the present invention (the timepiece dial of the present invention). An example of the configuration of the timepiece of the present invention is described below.

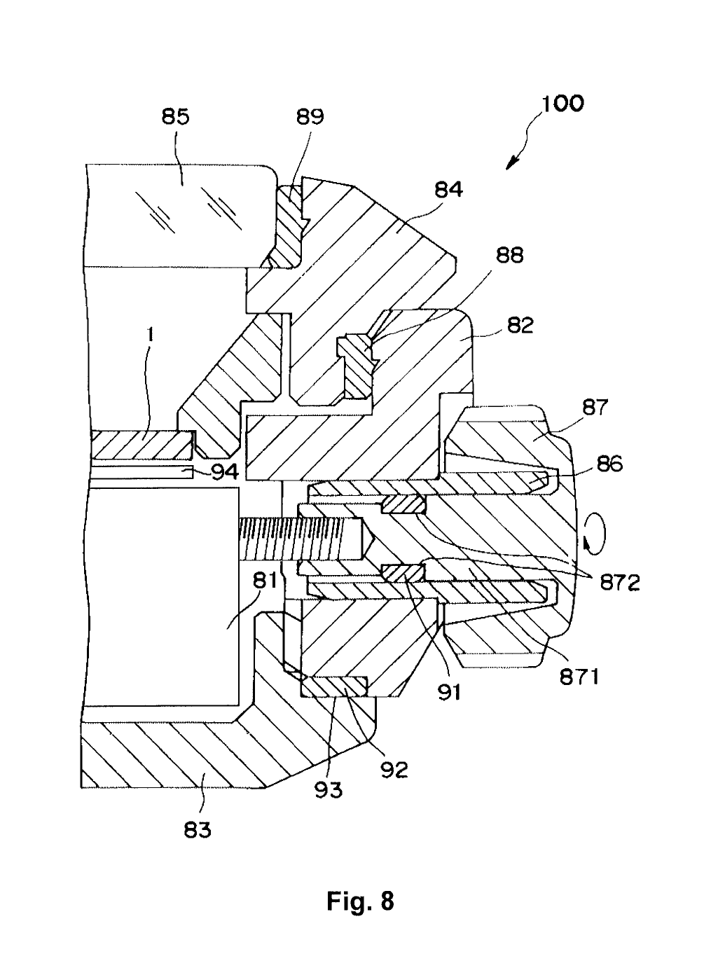

FIG. 8 is a cross-sectional view of a preferred embodiment of the timepiece (wristwatch) of the present invention. The wristwatch (portable timepiece) 100 of the present embodiment is provided with a case body (case) 82, a case back 83, a bezel (edge) 84, and a glass plate (cover glass) 85, as shown in FIG. 8. Also, inside of the case 82 includes the timepiece dial 1 of the present invention as described above, a solar battery 94, a movement 81, and index (indicator; not shown) and the like. The timepiece dial 1 is provided between the solar battery 94 and the glass plate (cover glass) 85, and the microlens layer 11 is arranged so as to face the glass plate (cover glass) 85 side.

The glass plate 85 is ordinarily composed of transparent glass, sapphire, or the like having high transparency. The aesthetic properties of the timepiece dial 1 of the present invention can thereby be sufficiently demonstrated, and a sufficient amount of light can be allowed to be incident on the solar battery 94. The movement 81 drives the index using the electromotive force of the solar battery 94.

Although not shown in FIG. 8, there are provided inside the movement 81, e.g., an electric double layer capacitor for storing the electromotive force of the solar battery 94, a lithium-ion secondary battery, a crystal oscillator as a time reference source, a semiconductor integrated circuit for generating a drive pulse for driving the timepiece on the basis of the oscillating frequency of the crystal oscillator, a step motor for driving the index in one-second increments on the basis of the drive pulse, a train wheel mechanism for transmitting the movement of the step motor to the index, and other components. Also, the movement 81 is provided with an antenna (not shown) for receiving radio waves, and has a function for performing time adjustment or the like using the received radio waves.

The solar battery 94 has a function for converting light energy into electric energy. The electric energy converted by the solar battery 94 is used for driving the movement and for other purposes. The solar battery 94 has, e.g., a p-i-n structure in which a p-type impurity and an n-type impurity are selectively introduced into non-single crystal silicon thin films, and an i-type non-single crystal silicon thin film having a low impurity concentration is provided between the p-type non-single crystal silicon thin film and the n-type non-single crystal silicon thin film.

A stem pipe 86 is fitted into and secured to the case 82, and a shaft part 871 of a crown 87 is rotatably inserted into the stem pipe 86. The case 82 and bezel 84 are secured by a plastic gasket 88, and the bezel 84 and glass plate 85 are secured by a plastic gasket 89. Also, the case back 83 is fitted (or threaded) onto the case 82, and a ring-shaped rubber gasket (case back gasket) 92 is intermediately inserted in a compressed state into these joining parts (seal parts) 93. This configuration fluid-tightly seals the joining parts, and a waterproof function is obtained.

A groove 872 is formed in the outer periphery of the crown 87 at a midway point of the shaft part 871, and a ring-shaped rubber gasket (crown gasket) 91 is fitted into the groove 872. The rubber gasket 91 is in close contact with the internal peripheral surface of the stem pipe 86, and is compressed between the internal peripheral surface and the inner surface of the groove 872. This configuration fluid-tightly seals the crown 87 and the stem pipe 86, and a waterproof function is obtained. When the crown 87 is rotatably operated, the rubber gasket 91 rotates together with the shaft part 871, and slides in the peripheral direction while in close contact with the internal peripheral surface of the stem pipe 86.

Among various types of timepieces, a watch (wristwatch) such as that described above particularly needs to be made thinner. Therefore, the present invention can be more advantageously applied in that the timepiece dial is made thinner and an excellent aesthetic appearance is obtained. In the description above, a wristwatch (portable timepiece) as a solar radio wave timepiece was described as an example of a timepiece, but the present invention can also be similarly applied to portable timepieces other than a wristwatch, a fixed timepiece, a wall timepiece, and various other types of timepieces. Also, the present invention can be applied to solar timepieces excluding solar radio wave timepieces, radio wave timepieces excluding solar radio wave timepieces, and any other timepiece.

Preferred embodiments of the present invention are described above, but the present invention is not limited to the description above. For example, with the timepiece dial and the timepiece of the present invention, the configuration of each part can be substituted with any configuration that demonstrates the same function, and any configuration can be added. For example, the timepiece dial and the timepiece of the present invention can have a printing part formed by the various printing methods. Also, at least one layer can be provided to the surface of the microlens layer and/or the decorative layer. Such a layer can be removed when, e.g., the timepiece dial enters service or at another time.

Also, in the embodiments described above, the microlenses were provided on the microlens layer with the same pattern, and however, it is possible to have a plurality of the regions where the arrangement pattern of the microlenses is different. Also, it is possible to consecutively change the pitches of the microlenses that are adjacent. In the embodiments described above, the description was focused on the case that when the timepiece dial is viewed from above, the linear design and/or the microlenses were not provided in the part where the time characters were provided. However, the linear design and/or the microlenses can be provided in the part where the time characters are provided when the timepiece dial is viewed from above.

In the embodiments described above, as a typical case, the microlens layer is provided with convex lenses as the microlenses, but the microlenses can be concave lenses as long as the focal points are connected on the surface side on which the decorative layer is provided. Also, in the embodiments described above, as a typical case, a pitch of the adjacent lines of the design changes along the longitudinal direction of reference line, but it can be possible that the pitch of the adjacent lines of the design does not change.

In the embodiments described above, as a typical case, the microlens layer provided with the microlenses and the decorative layer having the linear design are in close contact, but the microlens layer and the decorative layer do not need to be in close contact. For example, the timepiece dial can have a microlens substrate and a substrate provided with a decorative layer, which are spaced apart with a predetermined distance.

### EXAMPLES

Next, the concrete examples of the present invention will be explained.

### 1. Production of the Timepiece Dial

In each of the examples and the comparative examples, the timepiece dial (dial for wristwatch) is provided by the methods discussed below.

### Example 1

First of all, polycarbonate (absolute index of refraction: 1.586) is used for a base material, and the base material forming the dial for the wristwatch is made by the injection molding. After that, the necessary parts are cut out, and the unnecessary burrs and the like are removed. The microlens substrate forming a plurality of hemispherical microlenses is obtained by polishing the parts. The obtained microlens substrate forms an approximate disk shape and it has diameter: 27 mm×average thickness: 250 μm. The obtained microlens substrate has the microlenses formed on all over the first surface (except a part formed with time characters) which is the main surface in one side. Also, in the obtained microlens substrate, in a case where the centers of microlenses that are adjacent when the microlens substrate is viewed from above are connected by a straight line, a plurality of equilateral triangles are arranged in an orderly fashion by the straight line (see FIG. 1). The focal distance of the microlenses is 250 μm. The pitch P_{ML} of the microlenses is 120 μm. Also, the opposite side of the first surface, which is the main surface of the second surface, is a flat surface, and the surface roughness of the first surface Ra is 0.07 μm. After that, the time characters and marks are formed by the adhesive agent on a region where the microlenses are not formed on the first surface of the microlens substrate.

Next, polycarbonate is used for a base material, and the base material forming the dial for the wristwatch is made by the injection molding. After that, the necessary parts are cut out, and the unnecessary burrs and the like are removed. The substrate having a flat shape is obtained by polishing the parts. The obtained substrate forms an approximate disk shape and it has diameter: 27 mm×average thickness: 250 μm. Also, in the obtained substrate, the both sides of the main surfaces are a flat surface, and the surface roughness of these surfaces Ra is 0.07 μm.

The decorative substrate was obtained to form one straight line of the reference line (linear design) and a design formed of a plurality of curved lines (linear design) by the inkjet method on the first surface as one main surface of the above obtained substrate. The ink including C.I. Pigment Red 254 was used as an acrylate resin and pigments. The straight line of the reference line (linear design) was located on 3 o'clock position and 9 o'clock position of the timepiece dial. The straight line of the reference line was gone through the center when the substrate (timepiece dial) is viewed from above, and the thickness was 60 μm. Also, the curved lines of the design (linear design) were formed on the both upper and lower sides of the above reference line. Further, the pitch of the adjacent lines in a line perpendicular to the above reference line when the substrate (timepiece dial) is viewed from above was 115 μm. Moreover, in the lines of the design, the amount of the change of the pitch per unit length (1 cm) of the reference line was 1.15 μm (the change ratio of pitch: 1%). After that, the timepiece dial as shown in FIGS. 1 and 2 was obtained by superimposing the second surface of the microlens substrate and the first surface of the decorative substrate in contact.

### Examples 2˜13

In the same manner as described in example 1, the timepiece dial for wristwatch is provided except the conditions of the microlens substrate and the decorative substrate as shown in table 1.

### Comparative Example 1

In the same manner as described in example 1, the timepiece dial for the timepiece was provided except the microlens substrate was not provided and the decorative substrate was only provided. The time characters and marks were formed in the same manner as the microlens substrate of example 1.

### Comparative Example 2

In the same manner as described in example 1, the timepiece dial for the timepiece was provided except the decorative substrate was not provided and the microlens substrate was only provided.

### Comparative Example 3

The second surface of the decorative substrate forms one straight line of the reference line (linear design) and a design formed of a plurality of curved lines (linear design) by the inkjet method in the same manner as forming on the substrate in example 1. The ink including C.I. Pigment Red 254 was used as an acrylate resin and pigments. After that, the timepiece dial for the timepiece was provided in the same manner as comparative example 1 except the time characters and marks were formed on the first surface of the decorative substrate in the same manner as forming on the microlens substrate in example 1.

### Comparative Example 4

The timepiece dial for the timepiece is provided in the same manner as comparative example 3 except the thickness of the substrate is changed to 500 μm.

### Comparative Example 5

First, polycarbonate is used for a base material, and the base material forming the dial for the wristwatch is made by the injection molding. After that, the necessary parts are cut out, and the unnecessary burrs and the like are removed. The substrate having a flat shape is obtained by polishing the parts. The obtained substrate forms an approximate disk shape and it has diameter: 27 mm×average thickness: 250 μm. The printing layer was formed on all over the first surface, which is a main surface on one side of the substrate obtained as described above, by using the ink including C.I. Pigment Red 254 as an acrylate resin and pigments.

Next, the acryl uncured resin was added to all surface of the coating film, and in addition, the transparent coating film was formed by the thermal curing. The thickness of the transparent coating film was 50 μm. After that, one straight line of the reference line (linear design) and a design formed of a plurality of curved lines (linear design) were formed by the inkjet method in the same manner as forming on the substrate in example 1. The ink including C.I. Pigment Red 254 was used as an acrylate resin and pigments.

After that, in the same manner as discussed above, the process forming the transparent coating film and the linear design was repeated, and the entire thickness became 500 μm. At this point, the arrangement was made such that among the accumulated layers forming the plurality of lines of the design, two layers were not completely superimposed when the substrate was viewed from above. After that, the dial for the timepiece was obtained to form the time characters and marks on the surface of the accumulate layers body.

As a whole, table 1 shows each examples and comparative examples of the timepiece dial. Table 1 shows the focal distance L₀ [μm] of the microlenses, the distance L₁ [μm] from the lens surface of the microlenses to the surface of the decorative layer, the pitch P_{ML} [μm] of the microlenses, the pitch P_{R} [μm] of the adjacent lines of the design (a pitch of the adjacent lines of the design in a line perpendicular to the center of the reference line when the timepiece dial is viewed from above), and the amount of the changes (change rate) R [%] of the pitch of the lines of the design per unit length (1 cm) of the reference line. In the amount of the changes of the pitch of the lines of the design, a pitch increased from the center to the peripheral portion when the timepiece dial is viewed from above is a positive value, and a pitch reduced from the center to the peripheral portion when the timepiece dial is viewed from above is a negative value. Table 1 includes polycarbonate shown as PC, polyester resin shown as PEs, and acrylic resin shown as Ac. In the column “arrangement pattern” for the microlenses as shown in table 1, the arrangement pattern “a” is an arrangement in a case where the centers of microlenses that are adjacent when the timepiece dial is viewed from above are connected by a straight line, a plurality of triangles are arranged in an orderly fashion by the straight line as shown in FIG. 1. The arrangement pattern “b” is an arrangement in a case where the centers of microlenses that are adjacent when the timepiece dial is viewed from above are connected by a straight line, a plurality of squares are arranged in an orderly fashion by the straight line as shown in FIG. 3. In the column “arrangement pattern” for the linear design as shown in table 1, the arrangement pattern “c” is a pattern that a pitch of the adjacent lines of the design gradually increases from the center to the outer periphery of the timepiece dial as shown in FIG. 1. The arrangement pattern “d” is a pattern that a pitch of the adjacent lines of the design gradually reduces from the center to the outer periphery of the timepiece dial as shown in FIG. 3. The arrangement pattern “e” is a pattern that two groups of lines (a group of lines based on a straight line through 6 o'clock position and 12 o'clock position as a reference line, and a group of lines based on a straight line through 3 o'clock position and 9 o'clock position as a reference line) are formed as shown in FIG. 4. Also, a component was constituted as a main component in each part of the timepiece dial respectively as shown in table 1, and the content percentage of the rest of the components was less than 0.1 wt %.

TABLE 1

| | Microlens substrate | | | | | | Decorative plate | | | | | | |
|---|---|---|---|---|---|---|---|---|---|---|---|---|---|
| | | | | Microlens | | | Substrate | | Repeating design | | | | |
| | Compo- | | Average | Arrange- | | Focal | Compo- | Average | Arrange- | | | | |
| | nent | Index of | thickness | ment | Pitch P_{ML} | distance | nent | thickness | ment | Pitch | | | |
| | material | refraction | (μm) | pattern | (μm) | L₀ (μm) | material | (μm) | pattern | P_{R} (μm) | R (%) | L₁/L₀ | P_{R}/P_{ML} |
| Example 1 | PC | 1.586 | 250 | a | 120 | 250 | PC | 250 | C | 115 | 1 | 1 | 0.96 |
| Example 2 | PC | 1.586 | 300 | b | 120 | 300 | PC | 200 | d | 110 | −1 | 1 | 0.92 |
| Example 3 | PC | 1.586 | 250 | a | 160 | 250 | PC | 250 | e | 150 | −1 | 1 | 0.94 |
| Example 4 | PC | 1.586 | 400 | b | 200 | 400 | PC | 100 | d | 190 | −2 | 1 | 0.95 |
| Example 5 | Ac | 1.49 | 250 | a | 120 | 250 | PC | 250 | d | 125 | −3 | 1 | 1.04 |
| Example 6 | PEs | 1.54 | 250 | a | 120 | 250 | PC | 250 | d | 115 | −3 | 1 | 0.96 |
| Example 7 | PC | 1.586 | 100 | a | 120 | 100 | PC | 400 | e | 110 | −2 | 1 | 0.92 |
| Example 8 | PC | 1.586 | 800 | b | 200 | 800 | PC | 100 | e | 210 | −1 | 1 | 1.05 |
| Example 9 | PC | 1.586 | 250 | a | 60 | 250 | PC | 300 | e | 70 | 1.5 | 1 | 1.17 |
| Example 10 | PC | 1.586 | 400 | b | 400 | 400 | PC | 200 | c | 410 | 1.5 | 1 | 1.03 |
| Example 11 | Ac | 1.49 | 400 | b | 350 | 400 | PC | 200 | c | 340 | 2.5 | 1 | 0.97 |
| Example 12 | PC | 1.586 | 100 | a | 50 | 100 | PC | 500 | c | 60 | 3 | 1 | 1.2 |
| Example 13 | PEs | 1.586 | 600 | b | 450 | 600 | PC | 300 | e | 440 | 3 | 1 | 0.98 |
| Comparative | — | — | — | — | — | — | PC | 250 | c | 115 | 1 | — | — |
| example 1 | | | | | | | | | | | | | |
| Comparative | PC | 1.586 | 250 | a | 120 | 250 | — | — | — | — | — | — | — |
| example 2 | | | | | | | | | | | | | |
| Comparative | — | — | — | — | — | — | PC | 250 | c | 115 | | — | — |
| example 3 | | | | | | | | | | | | | |
| Comparative | — | — | — | — | — | — | PC | 500 | c | 115 | | — | — |
| example 4 | | | | | | | | | (both | | | | |
| | | | | | | | | | surfaces) | | | | |
| Comparative | — | — | — | — | — | — | PC | 100 | a | 110 | | — | — |
| example 5 | | | | | | | | | (multi- | | | | |
| | | | | | | | | | layering) | | | | |

### 2. Appearance Evaluation of Dial for Wristwatch (Evaluation of Stereoscopic Effect)

For each dial for the wristwatch provided in each discussed examples and comparative examples, by visually observing from the surface side forming the time characters, these appearances were evaluated based on 7 stages standard as discussed below.

A: Extremely excellent appearance with a rich stereoscopic effect.

B: Excellent appearance with a rich stereoscopic effect.

C: Excellent appearance with a stereoscopic effect.

D: Good appearance with a stereoscopic effect.

E: Slightly not-good appearance with an insufficient stereoscopic effect.

F: Not-good appearance with a weak stereoscopic effect.

G: Extremely no-good appearance with a weak stereoscopic effect.

### 3. Evaluation for the Optical Transmissivity of the Dial for Wristwatch

For each dial for the wristwatch provided in each discussed examples and comparative examples, the optical transmissivity was evaluated based on the methods discussed below. First, the solar battery and each dial for the wristwatch were stored in a dark room. After that, the light from a white fluorescent light (light source) was transmitted to the light receiving surface of the solar battery in a predetermined distance. At this point, the electric generation of the solar battery was A [mA]. Next, in a state that the dial for the wristwatch was superimposed on the upper surface of the receiving surface of the solar battery, the light from a white fluorescent light (light source) was transmitted in a predetermined distance in the same manner as discussed above. In this state, the electric generation of the solar battery was B [mA]. Then, the optical transmission ratio of the timepiece dial defined by the equation (B/A)×100 was computed and this was evaluated based on 5 stages standard as described below. As the optical transmission ratio becomes larger, the optical transmissivity of the timepiece dial is excellent. For the timepiece dial of each examples and comparative examples, the surface forming the time characters was set toward the white fluorescent light (light source) and the surface was superimposed on the solar battery.

A: 40% or more.

B: 32% or more and less than 40%.

C: 25% or more and less than 32%.

D: 17% or more and less than 25%.

E: less than 17%.

### 4. Evaluation of Radio Wave Transmissivity

For each dial for the wristwatch provided in each discussed examples and comparative examples, the radio wave transmissivity was evaluated based on the methods discussed below. First, a timepiece case and an inner module (movement) for the wristwatch formed with the radio wave receiving antenna were prepared. Next, the inner module (movement) for the wristwatch and the time characters for the wristwatch were built in the timepiece case. In this state, the receiving sensitivity of the radio wave was measured. At this time, for the timepiece dial of each examples and comparative examples, the surface forming the time characters was set toward the outer surface side.

A standard of the receiving sensitivity was defined in a state that the dial for the wristwatch was not installed. The lowering amount (dB) of the receiving sensitivity in a case that the dial for the wristwatch was installed was evaluated based on 4 stages standard as discussed below. As the receiving sensitivity of the radio wave becomes lower, the radio wave transmissivity of the timepiece for the wristwatch is excellent.

A: Not recognizing the lowering of the sensitivity (below the detection limit).

B: Recognizing that the lowering of the sensitivity is less than 0.7 dB.

C: Recognizing that the lowering of the sensitivity is 0.7 dB or more and less than 1.0 dB.

D: The lowering of the sensitivity is 1.0 dB or more.

These results are shown in table 2.

TABLE 2

| | Appearance | Optical | Radio wave |
|---|---|---|---|
| | evaluation | transmissivity | transmissivity |
| Example 1 | A | A | A |
| Example 2 | A | A | A |
| Example 3 | A | A | A |
| Example 4 | A | A | A |
| Example 5 | A | A | A |
| Example 6 | A | A | A |
| Example 7 | C | A | A |
| Example 8 | B | A | A |
| Example 9 | B | A | A |
| Example 10 | C | A | A |
| Example 11 | C | A | A |
| Example 12 | C | A | A |
| Example 13 | D | A | A |
| Comparative example 1 | G | A | A |
| Comparative example 2 | G | A | A |
| Comparative example 3 | F | A | A |
| Comparative example 4 | E | A | A |
| Comparative example 5 | E | A | A |

As shown in table 2, it is clear that the timepiece dial of the present invention has an excellent aesthetic appearance with a rich stereoscopic effect. Also, the timepiece dial of the present invention has an excellent optical transmissivity and radio wave transmissivity. On the other hand, the satisfied results were not obtained in the comparative examples. Also, by using the timepiece dial obtained from each examples and comparative examples, the timepiece was built as shown in FIG. 8. In each timepiece obtained from these examples and comparative examples, the same results discussed above were obtained by performing the same tests and evaluations as discussed above.

What is claimed is:

1. A timepiece dial comprising:
a microlens layer formed with a plurality of microlenses which are arranged in an orderly fashion as viewed in a planar view; and
a decorative layer formed with a design having a plurality of lines;
wherein the microlens layer and the decorative layer are superimposed as viewed in a planar view.

2. The timepiece dial according to claim 1, wherein
a pitch of adjacent lines of the design changes along a longitudinal direction of a linear reference line.

3. The timepiece dial according to claim 2, wherein
the plurality of lines of the design are that a change ratio of the pitch per unit length of the reference line is equal to each other in each section of the longitudinal direction of the linear reference line.

4. The timepiece dial according to claim 2, wherein
the pitch of the adjacent lines of the design is 40 μm or more and 550 μm or less.

5. The timepiece dial according to claim 2, wherein
a pitch P_{ML} [μm] of the microlenses and a pitch P_{R} [μm] of the adjacent lines of the design satisfy the relationship of 0.5≦P_{R}/P_{ML}≦1.5.

6. The timepiece dial according to claim 1, wherein
a focal distance L₀ [μm] of the microlenses and a distance L₁ [μm] from a lens surface of the microlenses to a surface of the decorative layer satisfy the relationship of 0.5≦L₁/L₀≦1.5.

7. The timepiece dial according to claim 1, wherein
the decorative layer is that in the lines of the design, a pitch of adjacent other lines of the design changes along the longitudinal direction of the lines of the design.

8. The timepiece dial according to claim 1, wherein
the decorative layer has a first group of lines formed of the plurality of the lines of the design which are not crossed or contacted from each other, and a second group of lines formed of the plurality of the lines of the design which are not crossed or contacted from each other;
at least one of the lines of the design constituting the first group of lines and at least one of the lines of the design constituting the second group of lines are crossed.

9. The timepiece dial according to claim 1, wherein
the decorative layer is that in the lines of the design, the change ratio of the pitch per unit length of the lines of the design is not constant.

10. The timepiece dial according to claim 1, wherein
in a case where the centers of microlenses that are adjacent as viewed in a planar view are connected by a straight line, a plurality of triangles are arranged in an orderly fashion by the straight line.

11. The timepiece dial according to claim 10, wherein
the triangles are equilateral triangles.

12. The timepiece dial according to claim 1, wherein
in a case where the centers of adjacent microlenses as viewed in a planar view of the timepiece dial are connected by a straight line, a plurality of quadrangles are arranged in an orderly fashion by the straight line.

13. The timepiece dial according to claim 12, wherein the quadrangles are squares.

14. The timepiece dial according to claim 1, wherein
the distance from the lens surface of the microlenses to the surface of the decorative layer is 100 μm or more and 1000 μm or less.

15. The timepiece dial according to claim 1, wherein
the focal distance of the microlenses is 100 μm or more and 1000 μm or less.

16. The timepiece dial according to claim 1, wherein
the pitch of the microlenses is 50 μm or more and 500 μm or less.

17. The timepiece dial according to claim 1, wherein
the lines of the design of the decorative layer and the microlenses of the microlens layer are provided in at least a portion where time characters are not provided as viewed in a planar view of the timepiece dial, and in a portion where the time characters are provided, the lines of the design of the decorative layer and/or the microlenses of the microlens layer are not provided.

18. A timepiece comprising the timepiece dial according to claim 1.
